(19) United States
(12) Patent Application Publication
(10) Pub. No.: US 2022/0344283 A1
(43) Pub. Date: Oct. 27, 2022

(54) SEMICONDUCTOR STRUCTURE

(71) Applicant: Winbond Electronics Corp., Taichung City (TW)

(72) Inventors: Chi-Ching Liu, Taichung City (TW); Hsiu-Pin Chen, Taichung City (TW); Sung-Ying Wen, Taichung City (TW); Tso-Hua Hung, Taichung City (TW); Yu-An Chen, Taichung City (TW); Ming-Che Lin, Taichung City (TW)

(73) Assignee: Winbond Electronics Corp., Taichung City (TW)

(21) Appl. No.: 17/586,654

(22) Filed: Jan. 27, 2022

(30) Foreign Application Priority Data
Apr. 26, 2021 (TW) 110114840

(51) Int. Cl. H01L 23/00; H01L 23/544; H01L 23/532

(52) U.S. Cl. CPC H01L 23/576; H01L 23/544; H01L 23/53223; H01L 23/53266; H01L 2223/54413; H01L 2223/5444

(57) ABSTRACT

A semiconductor structure serves to generate a physical unclonable function (PUF) code. The semiconductor structure includes a metal layer, N Titanium (Ti) structures, and N Titanium Nitride (Ti-N) structures, where N is a positive integer. The metal layer forms N metal structures. The Ti structures are respectively formed on one end of each metal structure. The Ti-N structures are respectively formed on top of the Ti structures. The metal structures and the corresponding Ti structures and the corresponding Ti-N structures respectively form a plurality of pillars. The pillars respectively provide a plurality of resistance values, and the resistance values serve to generate the PUF code.

### CROSS-REFERENCE TO RELATED APPLICATION

This application claims the priority benefit of Taiwan application serial no. 110114840, filed on Apr. 26, 2021. The entirety of the above-mentioned patent application is hereby incorporated by reference herein and made a part of this specification.

### BACKGROUND

### Technical Field

The disclosure relates to a semiconductor structure, specifically to generate the physical unclonable function (PUF) code semiconductor structure.

### Description of Related Art

To enhance security of chip use, generating physical unclonable function (PUF) codes in chips has become a trend in the market. The PUF codes may prevent data stored in the chip from being stolen. Here, the PUF codes serve to generate encryption keys through the unique fingerprint of each semiconductor element, and the generated keys can hardly be duplicated. The PUF code may also prevent reverse engineering attacks or damages to integrated circuits.

The PUF codes are often generated by applying the semiconductor structure in the chip; while the power is supplied, the semiconductor structure may be activated and randomly generate a digital value. The digital value of each chip is unique and thus may be considered as the fingerprint of the chip for data access identification.

### SUMMARY

The disclosure provides a semiconductor structure adapted to generate a physical unclonable function (PUF) code.

In an embodiment of the disclosure, a semiconductor structure is adapted to generate a PUF code. The semiconductor structure includes a metal layer, N titanium (Ti) structures, and N first titanium nitride (Ti-N) structures, wherein N is a positive integer. The metal layer forms N metal structures, and each of the Ti structures is respectively formed on one end of the metal structure. The first Ti-N structures respectively form on top of the Ti structures, wherein the metal structures, the Ti structures corresponding to the metal structures, and the first Ti-N structures corresponding to the metal structures respectively form a plurality of first pillars. The first pillars provide a plurality of resistance values, and the resistance values serve to generate the PUF code.

Based on the above, in one or more embodiments of the disclosure, the pillars composed of the metal structures, the Ti structures, and the Ti-N structures are formed on a chip. Since the pillars provide the resistance values with random distribution effects, the PUF code may be generated according to the resistance value of the pillars, so as to ensure confidentiality of chip operations.

In order to make the above features of the disclosure comprehensible, embodiments accompanied with figures are described in detail below.

### BRIEF DESCRIPTION OF THE DRAWINGS

FIG. 1 is a schematic diagram of a semiconductor structure according to an embodiment of the disclosure.

FIG. 2 is a schematic diagram of a semiconductor structure according to another embodiment of the disclosure.

FIG. 3 is a schematic diagram illustrating another way to implement the semiconductor structure according to an embodiment of the disclosure.

FIG. 4A and FIG. 4B are schematic diagrams illustrating different implementations of pillars of the semiconductor structure according to an embodiment of disclosure.

FIG. 5 is a schematic diagram illustrating another way to implement the semiconductor structure according to an embodiment of the disclosure.

### DETAILED DESCRIPTION OF THE EMBODIMENTS

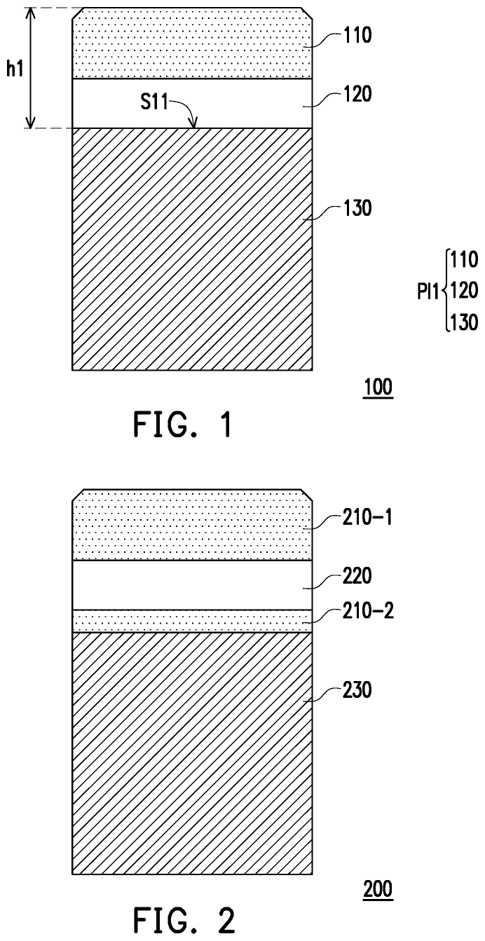

With reference to FIG. 1, a semiconductor structure 100 may be arranged in a chip and configured to provide a physical unclonable function (PUF) code. The semiconductor structure 100 includes a metal structure 130, a titanium (Ti) structure 120, and a titanium nitride (Ti-N) structure 110. The metal structure 130 may be formed by a metal layer in the chip, and a material of the metal layer may be aluminum.

In addition, the Ti structure 120 is formed on top of the metal structure 130; for example, the Ti structure 120 is formed at one side S11 of the metal structure 130. In a process of forming the Ti structure 120 on top of the metal structure 130, the Ti-N structure 110 may be formed on top of the Ti structure 120. During a semiconductor manufacturing process, the Ti-N structure 110 may serve as a conductive barrier layer between the metal structure 130 and a silicon substrate. The Ti-N structure 110 may prevent the metal structure 130 from being diffused to the silicon substrate and may also provide enough conductivity for electron transfer. The Ti-N structure 110 may be formed on top of the Ti structure 120 through a physical vapor deposition (PVD) process, an atomic layer deposition (ALD) process, or a chemical vapor deposition (CVP) process, which should however not be construed as limitations in the disclosure.

According to the embodiment, the metal structure 130, the Ti structure 120, and the Ti-N structure 110 compose a pillar PI1. The pillar PH may provide a resistance value. Based on the resistance value provided by the pillar PI1, a chip may generate a PUF code acting as a basis of chip identification.

According to the embodiment, the resistance value of the pillar PI1 is correlated to a thickness h1 of the Ti structure 120 and the Ti-N structure 110, a critical dimension (CD) of the pillar PI1, and time and a temperature of an annealing process performed on the metal structure 130. Specifically, the resistance value of a pillar PH may be positively correlated to the thickness h1 of the Ti structure 120 and Ti-N structure 110, but the resistance value of the pillar PI1 may be negatively correlated to the CD of the pillar PI1.

Note that the metal structure 130 may be formed by a first metal layer (metal 1) of the chip. The metal structure 130 may also be formed by a topmost metal layer of a chip formed in a copper process. In addition, in one chip, one or a plurality of semiconductor structures 100 may be formed. If one single chip contains plural semiconductor structures 100, the semiconductor structures 100 may correspondingly provide a plurality of multi-bit PUF codes.

On the other hand, in an embodiment of the disclosure, given that the metal structure 130 is made of aluminum, an aluminum nitride structure may be formed between the metal structure 130 and the Ti structure 120. According to the embodiment, the aluminum nitride structure formed between the metal structure 130 and the Ti structure 120 may have random physical characteristics and may randomly provide different resistance values.

Note that a plurality of the semiconductor structures 100 arranged on a plurality of chips in one wafer may provide the resistance values ranging from 42 kilo-ohm to 50 ohm. The resistance values of the semiconductor structures 100 may be randomly distributed and may serve as a fingerprint of each chip and a basis of chip identification. In addition, arrangement of a plurality of the semiconductor structures 100 in one single chip may further enhance the complexity of the chip fingerprint and thus effectively improve identification security.

With reference to FIG. 2, a semiconductor structure 200 may also be applied in chips and may also generate the PUF code through the resistance value provided by semiconductor structure 200. The semiconductor structure 200 includes a metal structure 230, a Ti structure 220, and Ti-N structures 210-1 and 210-2. The difference between the embodiment depicted in FIG. 1 and the embodiment depicted in FIG. 2 lies in that the Ti-N structure 210-2 exists between the Ti structure 220 and the metal structure 230. The thickness of the Ti-N structure 210-2 may be smaller than the thickness of the Ti-N structure 210-1. In some embodiments of the disclosure. A thickness of the Ti-N structure 210-2 may be greater than or equal to a thickness of the Ti-N structure 210-1. The thickness of the Ti-N structure 210-2 and the thickness of the Ti-N structure 210-1 may be controlled by controlling a time length of deposition in a deposition process, such as the PVD process, and the thickness control may be completed through the feedback of the measurement of the thickness.

In addition, given that the metal structure 230 contains aluminum, no aluminum nitride structure is formed between the metal structure 230 and the Ti-N structure 210-2 if the Ti-N structure 210-2 is deposited on the metal structure 230. In an embodiment of the disclosure, the Ti-N structure 210-2 may further contain other metal nitride, such as tantalum nitride (TaN) or the like.

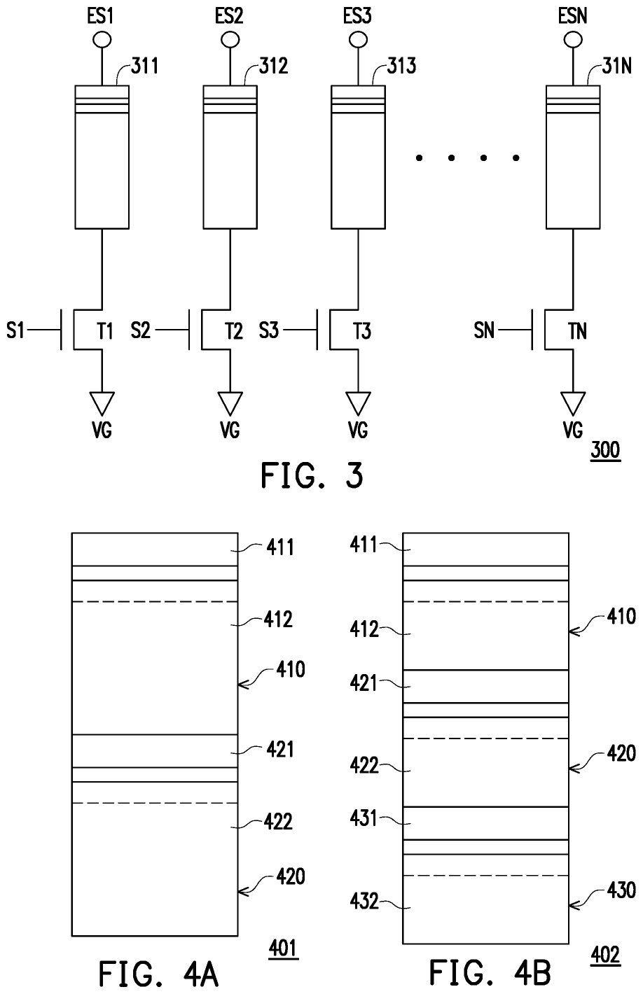

With reference to FIG. 3, which is a schematic diagram illustrating another way to implement the semiconductor structure according to an embodiment of the disclosure, a semiconductor structure 300 includes a plurality of pillars 311˜31N, and each of the pillars 311˜31N includes a metal structure, a Ti structure, and a Ti-N structure. According to the embodiment, the metal structures of the pillars 311˜31N may be formed by the same metal layer or different metal layers, which should however not be construed as a limitation in the disclosure. The semiconductor structure 300 further includes a plurality of transistors T1-TN. First terminals of the transistors T1˜TN are respectively coupled to the pillars 311˜31N; second terminals of the transistors T1˜TN may collectively receive a reference power supply VG, and control terminals of the transistors T1˜TN respectively receive scan signals S1˜SN. In addition, according to the embodiment, terminals of the pillars 311-31N which are not coupled to terminals of the transistors T1˜TN may respectively receive reference power supplies ES1˜ESN. Here, the reference power supply VG may be a grounded power supply, and the reference power supplies ES1˜ESN may be voltage sources or current sources different from the reference power supply VG.

While the PUF code is being read, the transistors T1˜TN may be turned on simultaneously or at different time points according to the scan signals S1˜SN. The pillar 311 is taken as an example. When the transistor T1 is turned on, if the reference power supply ES1 is a voltage source, the current flowing through the pillar 311 may be read to obtain read information; if the reference power supply ES1 is a current source, voltage differences at two ends of the pillar 311 may be read to obtain the read information. Besides, multiple read information may be obtained by turning on the transistors T2˜TN. Through combining the multiple read information corresponding to the pillars 311˜31N, the PUF codes may be generated.

Note that the above read information may be the sum of a plurality of analog current values or voltage values, and chips may convert the sum of the analog current values or voltage values through performing analog-digital conversion, so as to generate the digital PUF code. In another embodiment of the disclosure, through comparing whether the current value or voltage value of every read information is larger than a predetermined threshold value, the chips may respectively generate a plurality of digital codes corresponding to the pillars 311˜31N, and the chips generate the PUF codes through the combination of the digital codes.

Certainly, the details about how to generate the PUF codes as provided above are merely exemplary, and people having ordinary knowledge in the pertinent field may also obtain the digital PUF codes through different implementation details based on the resistance values respectively provided by the pillars 311˜31N, which should however not be construed as a limitation in the disclosure.

The transistors T1˜TN provided in one or more embodiments of the disclosure may transistors in any form, which should not be construed as a limitation in the disclosure.

Please refer to FIG. 4A and FIG. 4B, pillars may be implemented in form of a stacked structure. In FIG. 4A, a pillar 401 may be formed by cross-stacking a pillar 410 and a pillar 420, wherein the pillars 410 and 420 may have the same structures. The pillar 410 has a metal structure 412 and a Ti and Ti-N mixture structure 411. The pillar 420 has a metal structure 422 and a Ti and Ti-N mixture structure 421. The metal structures 412 and 422 may be made by different metal layers in the chip. In some embodiments, if the metal structures 412 and 422 are made of aluminum, the mixture structures 411 and 421 may further include an aluminum nitride structure (not shown in the drawings). Thicknesses of the Ti structures in the mixture structures 411 and 421 may be the same or different, which should not be construed as a limitation in the disclosure; thicknesses of the Ti-N structures in the mixture structures 411 and 421 may also be the same or different, which should neither be construed as a limitation in the disclosure.

In FIG. 4B, the pillar 402 is formed by stacking three different pillars 410, 420, and 430. In comparison with the pillar 401 shown in FIG. 4A, the pillar 402 further includes a pillar 430. The pillar 430 has a metal structure 432 and a Ti and Ti-N mixture structure 431. The metal structure 432 and the metal structures 412 and 422 may be formed by different metal layers in the chip.

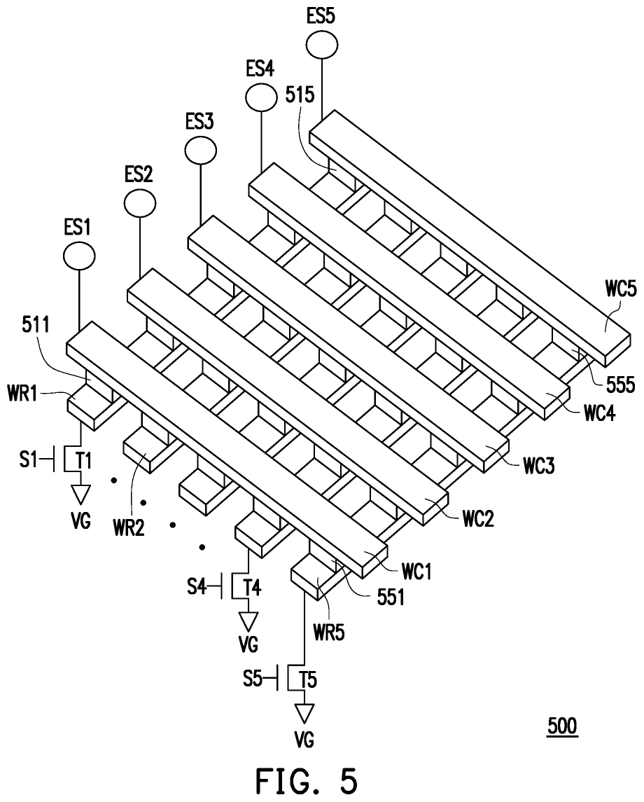

With reference to FIG. 5, which is a schematic diagram illustrating another way to implement the semiconductor structure according to an embodiment of the disclosure, a semiconductor structure 500 has a plurality of the pillars 511˜555 arranged in an array. In addition, the semiconductor structure 500 further includes a plurality of row wires WR1˜WR5 and column wires WC1˜WC5. Each of the pillars 511˜555 is coupled between one of the row wires WR1˜WR5 and one of the column wires WC1˜WC5. For example, the pillar 511 is coupled to the row wire WR1 and the column wire WC1. In addition, each of the pillars 511˜555 may be implemented in form of the structure illustrated in FIG. 1, FIG. 2, FIG. 4A, or FIG.4B, which should not be construed as a limitation in the disclosure.

In the embodiment, the semiconductor structure 500 further includes transistors T1˜T5, and the transistors T1˜T5 are respectively coupled to the row wires WR1˜WR5 and collectively coupled to the reference power supply VG. In the embodiment, the reference power supply VG may be a ground power supply. Control terminals of the transistors T1˜T5 respectively receive scan signals S1˜S5. In the embodiment, the column wires WC1˜WC5 respectively receive the reference power supplies E1˜E5.

As to the implementation details, the transistors T1˜T5 may be turned on at different time points according to the scan signals S1˜S5. For example, when the transistor T1 is turned on, a path may be respectively formed by the reference power supplies ES1˜ES5 and the transistor T1 through the column wires WC1˜WC5 and the pillars 511˜515. Hence, when a voltage source serves as the reference power supplies ES1—ES5, multiple read information may be obtained by measurement of the current passing through the pillars 511˜515. When a current source serves as the reference power supplies ES1˜ES5, multiple read information may be obtained by measurement of the voltage differences between two terminals of the pillars 511˜515. In view of the above, through sequentially turning on the transistors T1˜T5, multiple read information correlated to the resistance values of the pillars 511˜555 may be obtained.

After integration of the read information, the PUF codes may be obtained.

Note that the reference power supplies ES1˜ES5 may have the same value. As provided in the embodiment shown in FIG. 5, the pillars 511˜555 form a 5×5 array. In other embodiments of the disclosure, the number of the pillars may be more or less, which should not be construed as a limitation in the disclosure.

To sum up, according to one or more embodiments of the disclosure, one or more semiconductor structures formed by the metal structures, the Ti structures, and the Ti-N structures are arranged in the chip, and the resistance values provided by one or more semiconductor structures are applied to generate the PUF codes in the chip. Thereby, the mechanism of generating the PUF codes may be effectively achieved without occupying a significant area in the chip, and the security of chip access may be guaranteed.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A semiconductor structure, adapted to produce a physical unclonable function code, the semiconductor structure comprising:
a metal layer, forming N metal structures;
N titanium structures, respectively formed above the metal structures; and
N first titanium nitride structures, respectively formed above the titanium structures, wherein the metal structures, the titanium structures corresponding to the metal structures, and the first titanium nitride structures corresponding to the metal structures respectively form N first pillars, the N first pillars provide a plurality of resistance values for generating the physical unclonable function codes, and N is a positive integer.

2. The semiconductor structure according to claim 1, further comprising:
N second titanium nitride structures, respectively formed between the titanium structures and the metal structures.

3. The semiconductor structure according to claim 1, wherein a plurality of aluminum nitride structures are respectively located between the metal structures and the titanium structures.

4. The semiconductor structure according to claim 1, wherein each of the resistance values is positively correlated to a thickness of the corresponding titanium structure and the corresponding first titanium nitride structure

5. The semiconductor structure according to claim 1, wherein each of the resistance values is negatively correlated to a critical dimension of each of the first pillars.

6. The semiconductor structure according to claim 1, wherein each of the resistance values is correlated to a time and a temperature of an annealing process performed on each of the corresponding metal structures.

7. The semiconductor structure according to claim 1, wherein each of the metal structure is formed by the metal layer.

8. The semiconductor structure according to claim 1, wherein the first pillars are arranged in form of an array, the semiconductor structure further comprises a plurality of row wires and a plurality of column wires, each of the first pillars is coupled to one of the row wires and coupled to one of the column wires.

9. The semiconductor structure according to claim 8, further comprising:
a plurality of transistors, wherein first terminals of the transistors are respectively coupled to the row wires, control terminals of the transistors respectively receive a plurality of scan signals, second terminals of the transistors collectively receive a first reference power supply, and
the column wires receive a second reference power supply, wherein the first reference power supply is different from the second reference power supply.

10. The semiconductor structure according to claim 9, wherein the transistors are sequentially turned on according to the scan signals.

11. The semiconductor structure according to claim 1, further comprising:
N transistors, the transistors and the first pillars being respectively serially connected between a first reference power supply and a second reference power supply, wherein the first reference power supply is different from the second reference power supply, and the transistors are respectively controlled by a plurality of scan signals.

12. The semiconductor structure according to claim 11, wherein if each of the transistors is turned on and the corresponding reference power supply is a voltage source, a current flowing through the corresponding first pillar is read to obtain read information.

13. The semiconductor structure according to claim 12, wherein the read information is obtained by summing currents flowing through the first pillars, and a PUF code is obtained by converting the read information through an analog-digital conversion operation.

14. The semiconductor structure according to claim 12, wherein the current flowing through each of the first pillars is compared by a predetermined threshold value, each of a plurality of digital codes is obtained by converting each of the currents which is larger than the predetermined threshold value, and a PUF code in obtained by summing all of the digital codes.

15. The semiconductor structure according to claim 11, wherein if each of the transistors is turned on and the corresponding reference power supply is a current source, a voltage difference between two ends of the corresponding first pillar is read to obtain read information.

16. The semiconductor structure according to claim 15, wherein the voltage difference of each of the first pillars is compared by a predetermined threshold value, each of a plurality of digital codes is obtained by converting each of the voltage differences which is larger than the predetermined threshold value, and a PUF code in obtained by summing all of the digital codes.

17. The semiconductor structure according to claim 16, wherein the read information is obtained by summing voltage differences of the first pillars, and a PUF code is obtained by converting the read information through an analog-digital conversion operation.

18. The semiconductor structure according to claim 1, further comprising:
N second pillars, the second pillars and the first pillars being respectively overlapped, wherein a structure of each of the second pillars is identical to a structure of each of the first pillars.

19. The semiconductor structure according to claim 1, wherein the resistance value of each of the first pillars is between 42 kiloohm to 50 ohm.

20. The semiconductor structure according to claim 1, wherein each of the first titanium nitride structures further comprises tantalum nitride.
